(19) United States
(12) Patent Application Publication
(10) Pub. No.: US 2016/0226284 A1
(43) Pub. Date: Aug. 4, 2016

(54) METHOD AND APPARATUS FOR ELECTRICALLY CHARGING A HIGH-VOLTAGE BATTERY FROM AN AC POWER SUPPLY SYSTEM

(71) Applicant: Dr. Ing. h.c.F. Porche Aktiengesellschaft, Stuttgart (DE)

(72) Inventor: Daniel Spesser, Illingen (DE)

(21) Appl. No.: 15/006,279

(22) Filed: Jan. 26, 2016

(30) Foreign Application Priority Data
Jan. 29, 2015 (DE) 10 2015 101 283.9

(51) Int. Cl. H02J 7/00

(52) U.S. Cl. CPC H02J 7/0052; H02J 7/0029; H02J 7/0045

(57) ABSTRACT

A method for electrically charging a high-voltage battery, in particular a traction battery, from an AC power supply system includes connecting the high-voltage battery to the AC power supply system by means of a charging device (OBC) with a plurality of voltage rails (L1, L2, L3). A filter capacitor (Cy) is assigned to each voltage rail (L1, L2, L3). The method then includes calculating the highest possible charging power of the AC power supply system; selecting at least one voltage rail (L1, L2, L3) that is dispensable for the calculated charging power among the voltage rails (L1, L2, L3); and then switching off the filter capacitors (Cy) assigned to the dispensable voltage rails (L1, L2, L3). A corresponding apparatus, computer program and storage medium also are provided.

### CROSS REFERENCE TO RELATED APPLICATION

This application claims priority under 35 USC 119 to German Patent Appl. No. 10 2015 101 283.9 filed on Jan. 29, 2015, the entire disclosure of which is incorporated herein by reference.

### BACKGROUND

1. Field of the Invention

The invention relates to a method for electrically charging a high-voltage battery, in particular a traction battery, from an AC power supply system. The invention further relates to a corresponding apparatus, a corresponding computer program and a corresponding storage medium.

2. Description of the Related Art

Vehicle-side charging apparatuses for electrically driven vehicles are known. Such electrically driven vehicles have a DC high-voltage battery that can be connected to the stationary AC power supply system via a vehicle-side charging device to charge the DC high-voltage battery. The vehicle-side charging device comprises an input filter for interference suppression of the line-conducted emissions in the direction of the AC power supply system.

Special safety interference-suppression capacitors are sometimes used in power supply system filters of the type described. Safe and overvoltage-proof capacitors are used to suppress so-called common-read interference that occurs in the same phase on an external conductor and neutral conductor with respect to ground. However, this capacitive coupling causes an electric current that flows in an undesirable current path via the protective conductor under customary operating conditions. Such a current is known as leakage current to the electrical engineer in accordance with IEV 195-05-15 and can trip a residual current circuit breaker, for example.

Leakage current increases if plural charging devices are connected electrically in parallel on the vehicle side to increase the electrical charging power and legal stipulations may be exceeded as a result.

U.S. Pat. No. 5,672,952 attempts to reduce leakage current by using a battery charging controller that monitors the voltage across the power supply system element of an assigned charging device and opens a switch that inhibits the current flowing through the controller if the voltage across the pass element is substantially equal to zero.

US 2013/0308230 A1, by contrast, proposes a charging apparatus for a battery of a vehicle. The charging apparatus has an insulation resistance detecting circuit, a charging circuit, a leak current detecting circuit and a decoupling circuit. The insulation resistance detecting circuit contains a coupling capacitor and is arranged between the battery and a vehicle body for detecting an insulation resistance between the battery and the vehicle body. The charging circuit converts an alternating current supplied from an alternating current source into a direct current and charges the battery in a state without insulating the input terminal and the output terminal and in a state where the vehicle body is coupled to ground. The leak current detecting circuit detects a leak current between the charging circuit and ground. The decoupling circuit decouples the insulation resistance detecting circuit from the battery or the vehicle body during a charging of the battery.

### SUMMARY

The invention provides a method for electrically charging a high-voltage battery from an AC power supply system, a corresponding apparatus, a corresponding computer program and a corresponding storage medium.

The disclosed approach is based on an intelligent recognition of the available and connected AC infrastructure. This assessment of the boundary parameters enables an active and adaptive AC filter control. One advantage of this solution resides in the reduction of the leakage current that is achieved by the preventive disconnection of individual voltage rails.

The filter capacitor that connects the voltage rail to the protective conductor of the AC power supply system can be embodied as a Y capacitor according to IEC 60384-1. Such a capacitor, with limited capacitance, considerably reduces the risk of failure due to short circuit and thus improves the electrical and mechanical safety.

The Y capacitor may be switched off by a metal oxide semiconductor field effect transistor that connects the Y capacitor to the protective conductor. Corresponding power transistors are distinguished by a fast switching time and stable amplification and response times.

An exemplary embodiment of the invention is illustrated in the drawing and is described in greater detail below.

### BRIEF DESCRIPTION OF THE DRAWING

FIG. 1 illustrates the fundamental functioning of the invention.

### DETAILED DESCRIPTION

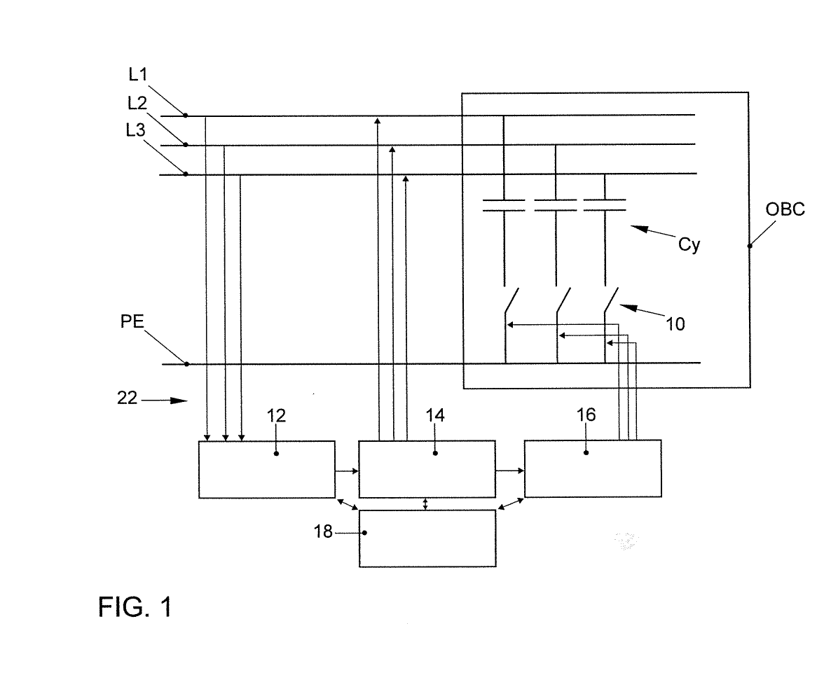

FIG. 1 illustrates the effect of a method in accordance with one embodiment of the invention on the basis of the vehicle-side charging device OBC for the traction battery—not itself illustrated—of an electrically driven vehicle. For this purpose, a computer program is stored on the machine-readable storage medium of a suitable control unit of the vehicle. The computer program is designed to perform the method steps described below.

The traction battery is a high-voltage battery connected to the AC power supply system by means of the charging device OBC. To increase the interference immunity, the charging device OBC has a power supply system filter comprising three filter capacitors Cy. Each of the filter capacitors Cy is a Y capacitor Cy and can connect the voltage rail L1, L2, L3 of the charging device OBC that is assigned thereto to the protective conductive PE of the AC power supply system. Optionally, however, each of the connections described can be interrupted by a metal oxide semiconductor field effect transistor 10 that is arranged between the respective Y capacitor Cy and the protective conductor PE.

According to the invention, the highest possible charging power of the AC power supply system now is calculated by an AC voltage measurement 22 by a charging power calculation module 12—represented merely schematically at the lower edge of the figure. A voltage rail selection module 14 connected to the charging power calculation module 12 then selects from among the voltage rails L1, L2, L3, if appropriate one or a plurality of voltage rails L1, L2, L3, which are not absolutely required for providing the calculated charging power, and passes this information on to a connected filter capacitor switch-off module 16. Charging power calculation module 12, voltage rail selection module 14 and filter capacitor switch-off module 16 here are in each case connected bi-directionally to an associated safety interrogation module 18.

On the basis of the control instructions available to it, the filter capacitor switch-off module 16 finally selects a suitable switching matrix, which is at least partly implemented by the metal oxide semiconductor field effect transistor 10, and disconnects the Y capacitor Cy from the protective conductor PE. A possible leakage current from the Y capacitor Cy via the metal oxide semiconductor field effect transistor 10 into the protective conductor PE is interrupted in this way.

What is claimed is:

1. A method for electrically charging a high-voltage battery from an AC power supply system, comprising:
connecting the high-voltage battery to the AC power supply system by a charging device comprising a plurality of voltage rails, with a filter capacitor being assigned to each voltage rail;
calculating a highest possible charging power of the AC power supply system;
selecting at least one voltage rail that is dispensable for the calculated charging power among the voltage rails; and
switching off the filter capacitors assigned to the dispensable voltage rails.

2. The method of claim 1, wherein the filter capacitor assigned to a voltage rail connects the voltage rail to a protective conductor of the AC power supply system, wherein the filter capacitor is a Y capacitor.

3. The method of claim 2, wherein the Y capacitor is switched off by a metal oxide semiconductor field effect transistor that connects the Y capacitor to the protective conductor.

4. The method of claim 3, wherein the Y capacitor is switched off by a switching matrix of the charging device that comprises the metal oxide semiconductor field effect transistor being selected.

5. The method of claim 1, wherein calculating the charging power, selecting the voltage rails and switching off the filter capacitors comprise a safety interrogation.

6. The method of claim 1, wherein calculating the charging power comprises an AC voltage measurement.

7. An apparatus for electrically charging a high-voltage battery from an AC power supply system, comprising:
a first connection connectable to the high-voltage battery;
a second connection connectable to the AC power supply system;
a plurality of voltage rails and filter capacitors assigned respectively to each of the voltage rail;
a charging power calculation module for calculating a highest possible charging power of the AC power supply system;
a voltage rail selection module connected to the charging power calculation module and configured to select a voltage rail that is dispensable for the calculated charging power among the voltage rails; and
a filter capacitor switch-off module connected to the voltage rail selection module and configured for switching off the filter capacitors assigned to the dispensable voltage rails.

8. The apparatus of claim 7, further comprising a safety interrogation module connected to the charging power calculation module, the voltage rail selection module and the filter capacitor switch-off module.

9. A computer program designed to carry out all the steps of the method of claim 1.

10. A machine-readable storage medium comprising the computer program of claim 9 stored thereon.
